(19) United States
(12) Patent Application Publication
(10) Pub. No.: US 2010/0129079 A1
(43) Pub. Date: May 27, 2010

(54) OPTICAL WDM TRANSMISSION APPARATUS AND OPTICAL WDM TRANSMISSION METHOD

(75) Inventors: Koji Bato, Kawasaki (JP); Hideaki Sugiya, Kawasaki (JP); Ichiro Nakajima, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/612,264

(22) Filed: Nov. 4, 2009

(30) Foreign Application Priority Data
Nov. 27, 2008 (JP) 2008-301979

(51) Int. Cl. H04J 14/02

(52) U.S. Cl. 398/79

(57) ABSTRACT

An optical WDM transmission apparatus includes plural optical attenuators that respectively attenuate the power of optical signals separated according to wavelength; plural first optical receivers that respectively detect the power of the attenuated optical signals; a multiplexer that multiplexes the optical signals; a second optical receiver that detects the power of the multiplexed optical signal; and a monitoring control unit that includes a first control system that controls the optical attenuators so that the powers detected at the first optical receivers respectively become target values, and a second control system that, based on the power detected by the second optical receiver and information concerning the number of wavelengths corresponding to the optical signals input, controls the optical attenuators so that the powers of the optical signals respectively become the target values.

### CROSS REFERENCE TO RELATED APPLICATIONS

This application is based upon and claims the benefit of priority of the prior Japanese Patent Application No. 2008-301979, filed on Nov. 27, 2008, the entire contents of which are incorporated herein by reference.

### FIELD

The embodiments discussed herein are related to an optical wavelength division multiplexer (WDM) transmission apparatus and optical WDM transmission method.

### BACKGROUND

FIG. 8 is a schematic depicting an example of a typical wavelength division multiplexer (WDM) transmission apparatus. The configuration depicted in FIG. 8 is of an optical WDM transmission apparatus that selects from among light separated according to wavelength and light input from an external apparatus. An optical WDM transmission apparatus 800 includes a preamplifier 801 provided upstream at the input of an optical signal and having an amplifier 810 that amplifies the optical signal; a wavelength separating unit 802 that includes a demultiplexer (DMUX) 820, which demultiplexes a multiplexed optical signal according to wavelength (channels ch1 to chn); an optical power varying unit 803 that includes a optical attenuator (VOA) 830 for each wavelength and changes the power of the optical signal by adjusting the level of attenuation; a wavelength multiplexing unit 804 that includes a multiplexer (MUX) 840 and multiplexes the optical signals of differing wavelengths into a multiplexed signal; and an optical amplifier 805 that amplifies the multiplexed signal using a post amplifier 850 and transmits the amplified multiplexed signal to a subsequent station such as another optical WDM transmission apparatus (see, for example, Japanese Laid-Open Patent Publication No. 2001-197010).

The preamplifier 801 further includes a detector (PD) 811 that is upstream from the amplifier 810 and detects the power of the optical signal input to the amplifier 810 and a detector (PD) 812 that is downstream from the amplifier 810 and detects the power of the optical signal amplified and output by the amplifier 810. The optical amplifier 805 further includes a detector (PD) 851 that is upstream from the post amplifier 850 and detects the power of the optical signal input to the post amplifier 850 and a detector (PD) 852 that is downstream from the post amplifier 850 and detects the power of the optical signal amplified and output by the post amplifier 850.

The optical power varying unit 803 further includes optical receivers (PD1) 831 that are downstream from the VOAs 830 and detect the power of the optical signals transmitted through the VOAs 830.

According to the configuration depicted in FIG. 8, ADD light of each channel may be input from external sources through ports 860. Further, light separated according to wavelength by the wavelength separating unit 802 may be transmitted as is and output to the optical power varying unit 803. Another configuration example may output to an external destination through the ports 860, light separated according to wavelength by the wavelength separating unit 802, or output to the optical power varying unit 803, light input through the ports 860 and separated according to wavelength.

FIG. 9 is a schematic depicting components of the optical WDM transmission apparatus related to optical power control. The example depicted in FIG. 9 includes the optical power varying unit 803 and the wavelength multiplexing unit 804 depicted in FIG. 8. The optical WDM transmission apparatus 800 further includes a monitoring control unit 870 that monitors the power of the optical signal. The monitoring control unit 870 includes a monitoring unit 871 that monitors detection values of the optical receivers (PD1) 831 respectively provided for each wavelength of the optical power varying unit 803; a storage unit 872 storing therein power control parameters; a calculating unit 873 that, based on the parameters stored in the storage unit 872 and the detection values monitored by the monitoring unit 871, calculates a control value for the power of the optical signal; and a VOA control unit 874 that variable controls the attenuation levels of the VOAs 830 respectively provided for each wavelength. An external terminal 882 outputs a target input power value for the post amplifier 850 per channel and an amplified spontaneous emission (ASE) correction value, the storage unit 872 storing both as parameters.

When the power of the optical signals is adjusted, an external variable wavelength optical power source 880 is connected to the ports 860 and optical signals of each wavelength (ch1 to n) are input. A power meter 881 is connected to an output port 845 of the wavelength multiplexing unit 804 and the power of the optical signal passing through the optical power varying unit 803 and the wavelength multiplexing unit 804 is measured.

Control of the power adjustment executed by the monitoring control unit 870 includes:

1) The VOA control unit 874 fully opening (setting to the minimum attenuation level) all of the VOAs (ch1 to n) and measuring, per channel, the optical loss (Ltotal_w, where w is each channel) occurring in the paths from the ports 860 (optical input terminal) to the output port 845 (output terminal of the wavelength multiplexing unit 804). At this time, since measurement is simplified, the power of the optical signal input from the variable wavelength optical power source 880 is 0 dBm/ch.
2) The optical signal power (OP_w) detected by the optical receivers (PD1) 831 respectively provided for each channel being recorded and stored in the storage unit 872.
3) Setting a target power (Otgt_w) per channel to suppress optical power differences between channels in the multiplexed optical signal input to the post amplifier 805. The set values are recorded to the storage unit 872.
4) The calculating unit 873 calculating optical loss (Lmux_w) for each channel of the wavelength multiplexing unit 804. The calculation equation being Lmux_w=Ltotal_w−OP_w.
5) By adding optical loss to the target powers per channel, the calculating unit 873 calculating a range in which the optical receivers (PD1) 831 preferably detect the power of the optical signals. The calculation equation being Opd1_w=Otgt_w+Lmux_w.
6) Subsequently, the attenuation levels of the VOAs 830 being adjusted through the VOA control unit 874 so that the optical signal powers are detected by the optical receivers (PD1) 831 within the range Opd1. Thus, based on the power of each optical signal before multiplexing and preliminarily measured information of the control unit, the power of the optical signal at each wavelength is calculated and control is performed (see, for example, Japanese Laid-Open Patent Publication No. 2007-067759).

However, with the conventional technology above, optical signal power is not appropriately controlled when wideband noise (ASE) is included in the input optical signal. FIG. 10 is a schematic depicting the state of an optical signal with respect to the MUX provided in the wavelength multiplexing unit. Wavelength is indicated along the horizontal axis, while power is indicated along the vertical axis. In this example, the optical receiver (PD1) 831 provided in the optical power varying unit 803 is able to measure only the total power of an optical signal that includes ASE. As depicted in (a) of FIG. 10, the optical receivers (PD1) 831 provided upstream of the MUX 840 detect an optical signal λ1 that includes wideband ASE (for convenience in the explanation hereinafter, among the optical signal wavelengths λ1 to n, explanation is given for only λ1).

According to the nature of wavelength multiplexing, the MUX 840 transmits the optical signal λ1 as depicted in (b) of FIG. 10 and thus, the wavelength multiplexing unit 804 provided downstream from the optical power varying unit 803 has a filter property. As a result of the filter property, the optical signal output from the MUX 840 includes a component of the optical signal and only ASE near the wavelength of the optical signal transmitted through the MUX 840, as depicted in (c) of FIG. 10. Thus, by adjusting the VOAs 830 according to only the power detected by the optical receivers (PD1) 831, the power of the optical signal input for each channel to the post amplifier 805 is below the desirable set value because the power detected by the optical receivers (PD1) 831 includes that of ASE components, which cover a wideband and are removed during transmission through the MUX 840, as depicted in (d) of FIG. 10.

According to the control of the VOAs 830 based on power detection at such optical receivers (PD1) 831, the difference between target values set for the post amplifier 805 and the actual optical power output by the wavelength multiplexing unit 804 becomes significant. Thus, due to the size of ASE components of the input optical signal and bandwidth of the optical signal, optical signal power is not adjusted to a proper value, for each wavelength after multiplexing. Specifically, the total power of the multiplexed wavelengths is not adjusted to a target value and wavelength deviation in the power of the optical signals of each wavelength occurs inhibiting improvement in the quality of the optical signals.

### SUMMARY

According to an aspect of an embodiment, an optical WDM transmission apparatus includes plural optical attenuators that respectively attenuate the power of optical signals separated according to wavelength; plural first optical receivers that respectively detect the power of the attenuated optical signals; a multiplexer that multiplexes the optical signals; a second optical receiver that detects the power of the multiplexed optical signal; and a monitoring control unit that includes a first control system that controls the optical attenuators so that the powers detected at the first optical receivers respectively become target values, and a second control system that, based on the power detected by the second optical receiver and information concerning the number of wavelengths corresponding to the optical signals input, controls the optical attenuators so that the powers of the optical signals respectively become the target values.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic depicting a configuration of optical power adjustment before operation of an optical WDM transmission apparatus according to a first embodiment;

FIG. 2 is a flowchart of pre-operation processing;

FIG. 3 is a schematic of parameters stored to the storage unit during the processing depicted in FIG.;

FIG. 4 is a schematic depicting a configuration of optical power adjustment during operation of the optical WDM transmission apparatus according to the first embodiment;

FIG. 5 is a flowchart of control processing during operation;

FIG. 6 is a schematic depicting a configuration of optical power adjustment before operation of an optical WDM transmission apparatus according to a second embodiment;

FIG. 7 is a flowchart of control processing during operation;

FIG. 8 is a schematic depicting an example of a typical WDM transmission apparatus;

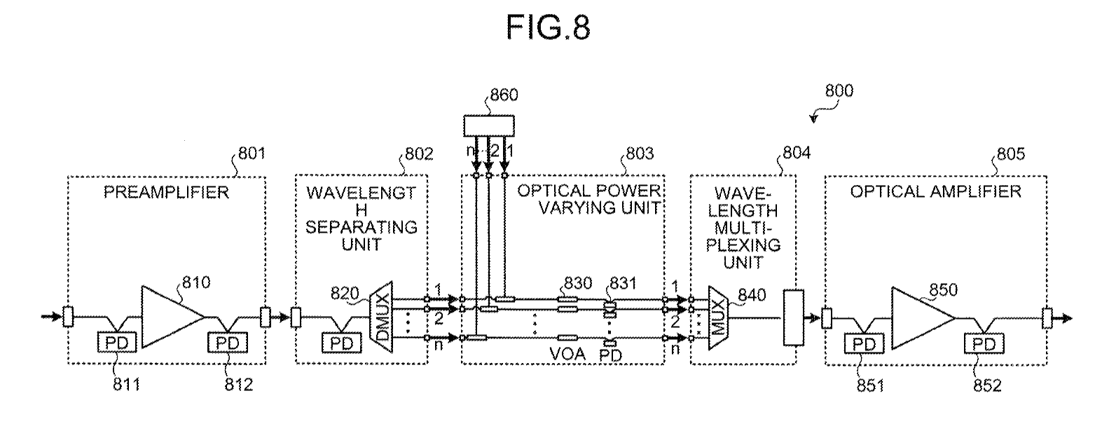

FIG. 9 is a schematic depicting components of the optical WDM transmission apparatus related to optical power control; and

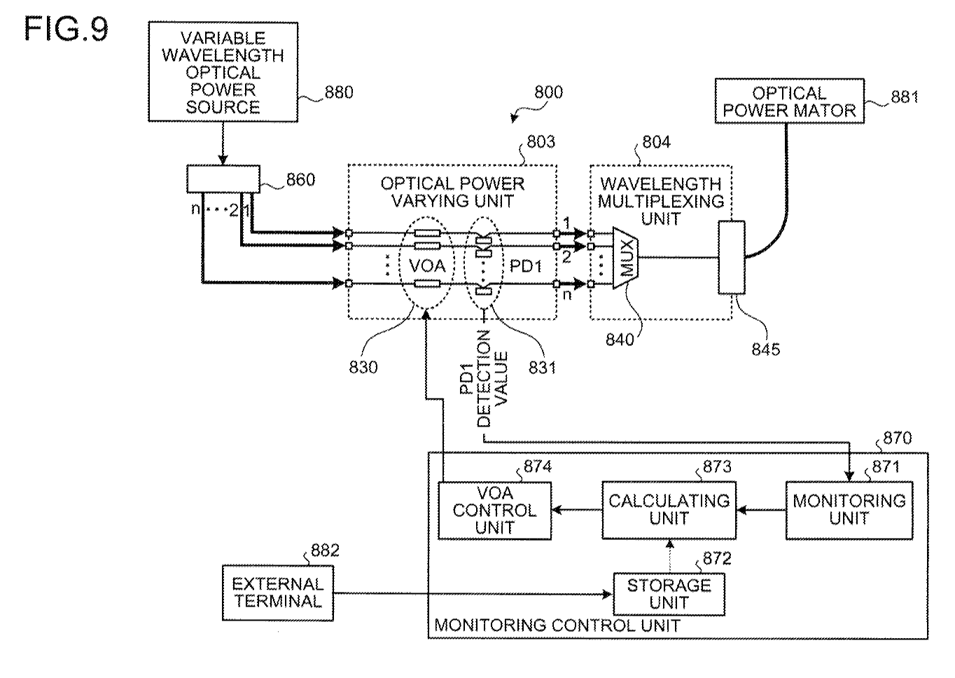

FIG. 10 is a schematic depicting the state of an optical signal with respect to the MUX provided in the wavelength multiplexing unit.

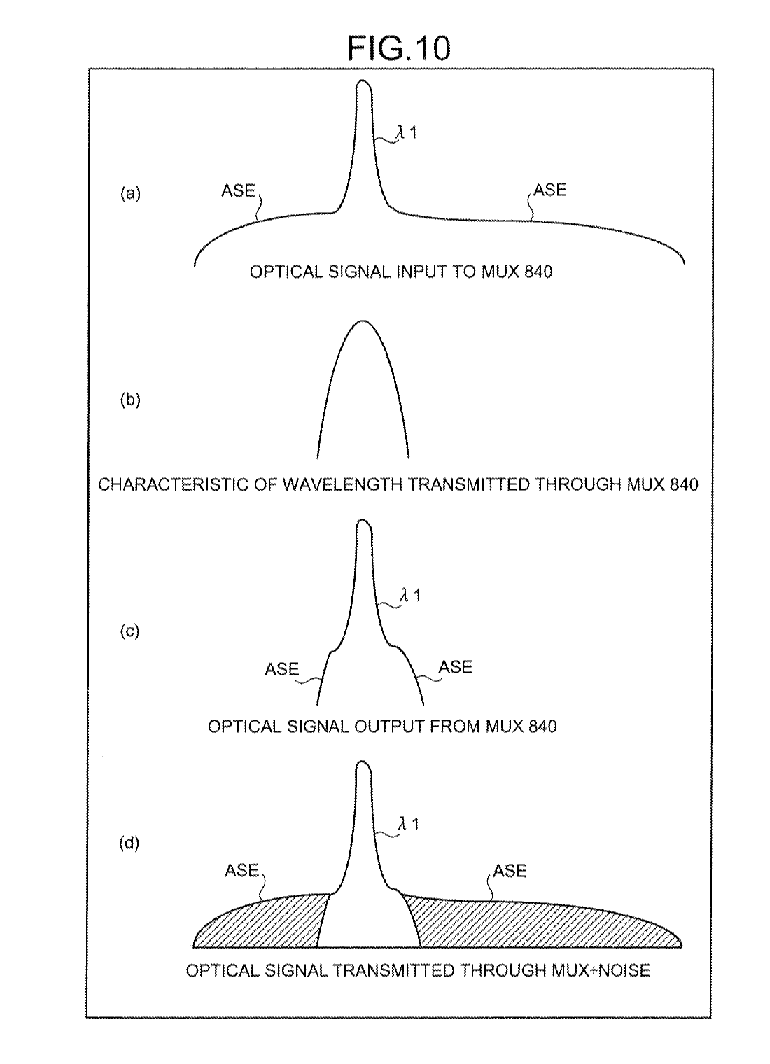

### DESCRIPTION OF EMBODIMENTS

Preferred embodiments of the present invention will be explained with reference to the accompanying drawings. An optical WDM transmission apparatus according the present invention includes a control system that, based on the power of each optical signal separated according to wavelength, adjusts the power of each optical signal, and a control system that adjusts the power of each optical signal by detecting the optical signal power after multiplexing and performing a given calculation. The optical power of a multiplexed optical signal id detected using an optical receiver provided in a wavelength mulitplexing unit. Thus, the power of each optical signal separated according to wavelength is adjusted by VOAs to adjust the post-multiplexing optical power.

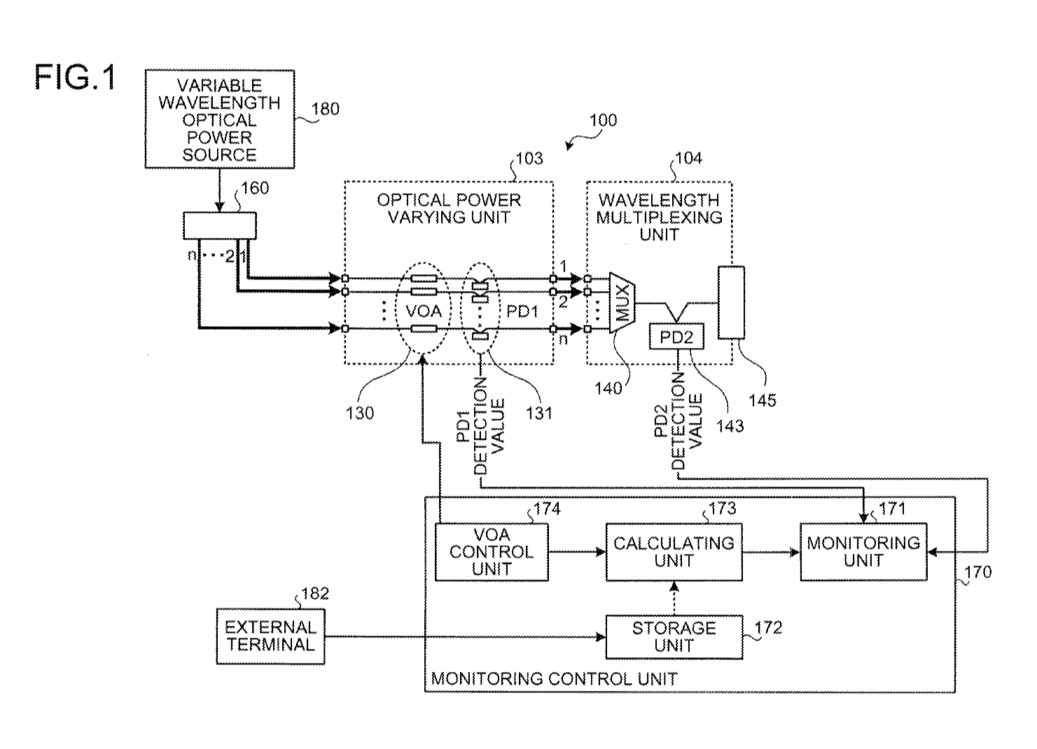

A first embodiment assumes a configuration that receives input of optical signals separated according to wavelength. FIG. 1 is a schematic depicting a configuration of optical power adjustment before operation of an optical WDM transmission apparatus according to the first embodiment. A portion of the configuration of an optical WDM transmission apparatus 100 is depicted in FIG. 1. The optical WDM transmission apparatus 100, on an input side, includes ports 160 to which a variable wavelength optical power source 180 is connected. The variable wavelength optical power source 180 inputs optical signals of wavelengths λ1 to n to the optical WDM transmission apparatus 100.

An optical power varying unit 103 includes an optical attenuator (VOA) 130 for each wavelength and adjusts (attenuates) the power of the optical signals of each wavelength. Optical receivers (PD1) 131 downstream from the VOAs 130 detect the power of the optical signals after attenuation. A wavelength multiplexing unit 104 includes a MUX 140 and multiplexes the optical signals output from the optical power varying unit 103. An optical receiver (PD2) 143 detects the total power of the multiplexed signal.

Thus, the attenuation level of each of the VOAs 130 is controlled by the detection by the optical receivers (PD1) 131 respectively provided immediately downstream from the VOAs 130 and for each wavelength. Additionally, the detection value of the optical receiver (PD2) 143 provided downstream from the MUX 140 is used. Specifically, the power of the optical signal at each wavelength is obtained. Consequently, loss at the MUX 140 and the ASE of each wavelength is considered and the attenuation level of each of the VOAs 130 is appropriately controlled.

A monitoring control unit 170 acquires the detection values of the optical receivers (PD1) 131 that detect the power of the optical signals at each wavelength of the optical power varying unit 103, and the detection value of the optical receiver (PD2) 143 that detects the power of the multiplexed optical signal. The monitoring control unit 170 includes a monitoring unit 171; a storage unit 172 storing therein power control parameters; a calculating unit 173 that, based on the parameters stored in the storage unit 172 and a monitoring value of the monitoring unit 171, calculates a control value for optical signal power; and a VOA control unit 174 that, based on the calculated control value, variably controls the attenuation level of the VOAs 130. An external terminal 182 outputs a per-channel, target input power value for a post amplifier; the storage unit 172 stores target input power value as a parameter.

When the power of the optical signal is adjusted, an external variable wavelength optical power source 180 is connected to the ports 160 and optical signals of each wavelength (ch1 to n) are input. The optical signals are separated according to wavelength, i.e., the power of each of the optical signals before multiplexing is detected by the optical receivers (PD1) 131 and the power of the multiplexed signal is detected by the optical receiver (PD2) 143.

Control of the optical signal power according to the configuration above is roughly separated into pre-operation preparation and control during operation, and is executed by the monitoring control unit 170.

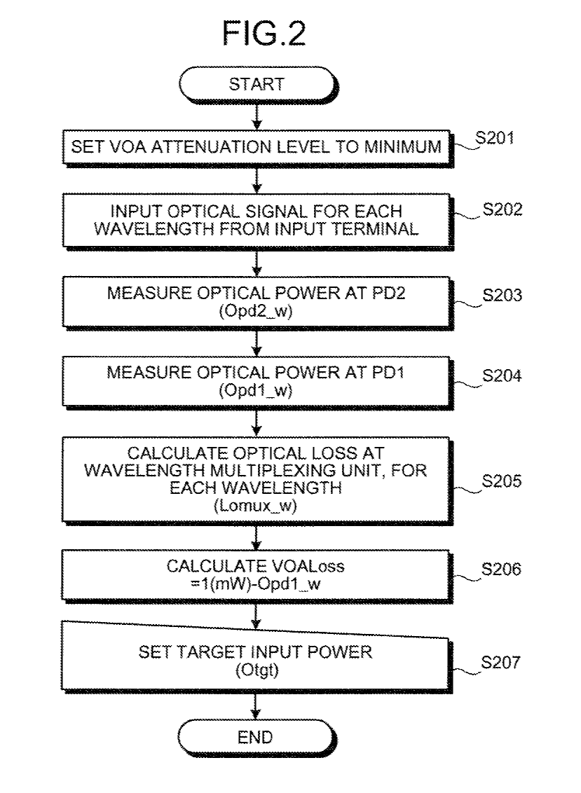

FIG. 2 is a flowchart of pre-operation processing. The VOA control unit 174 of the monitoring control unit 170 fully opens (sets to the minimum attenuation level) all of the VOAs 130 (step S201). The variable wavelength optical power source 180 inputs an optical signal for each wavelength to the ports 160 (step S202). For convenience in the explanation hereinafter, the input power here is 1 mW.

The optical receivers (PD1, PD2) 131, 143 respectively detect the power of the light received. The optical receiver (PD2) 143 detects an optical power Opd2_w (step S203). The optical receivers (PD1) 131 detect an optical power Opd1_w (step S204). w is a given wavelength. The optical power Opd1_w and Opd2_w are stored in the storage unit 172.

The calculating unit 173, based on the difference between the optical power Opd1_w and the optical power Opd2_w, calculates, for each wavelength, optical loss (Lomux_w) occurring in the wavelength multiplexing unit 104 (step S205). Here, optical loss occurring in paths from the ports 160 to the optical receiver (PD2) 143 is calculated, for each wavelength, using the difference of the input power and the optical power Opd2_w; optical loss occurring in paths from the ports 160 to the optical receivers (PD1) 131 is calculated, for each wavelength, using the difference of the input power and the optical power Opd1_w; and based on the differences between the above calculation results, optical loss Lomux_w at the MUX 140 is obtained for each wavelength.

The calculating unit 173 calculates loss VOALoss at the VOAs 130 (step S206). The calculation is performed using the difference of the power of the optical signal input to one of the ports 160 and the optical power Opd1_w detected by the optical receivers (PD1) 131; i.e., 1 mW-Opd1_w. The value obtained indicates the minimum loss (min) at the corresponding VOA 130. The loss at the VOA VOALoss (min) is stored in the storage unit 172.

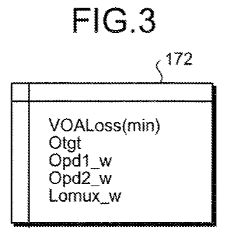

The target input power Otgt for the post amplifier provided downstream from the wavelength multiplexing unit 104 is set (step S207). The target input power Otgt is stored in the storage unit 172. FIG. 3 is a schematic of parameters stored to the storage unit during the processing depicted in FIG. 2. Although explanation of the above processing has been given with respect to one wavelength, the processing is executed with respect to each of the wavelengths λ1 to n, optical loss Lomux_w at the MUX 140 is recorded to the storage unit 172 for each wavelength.

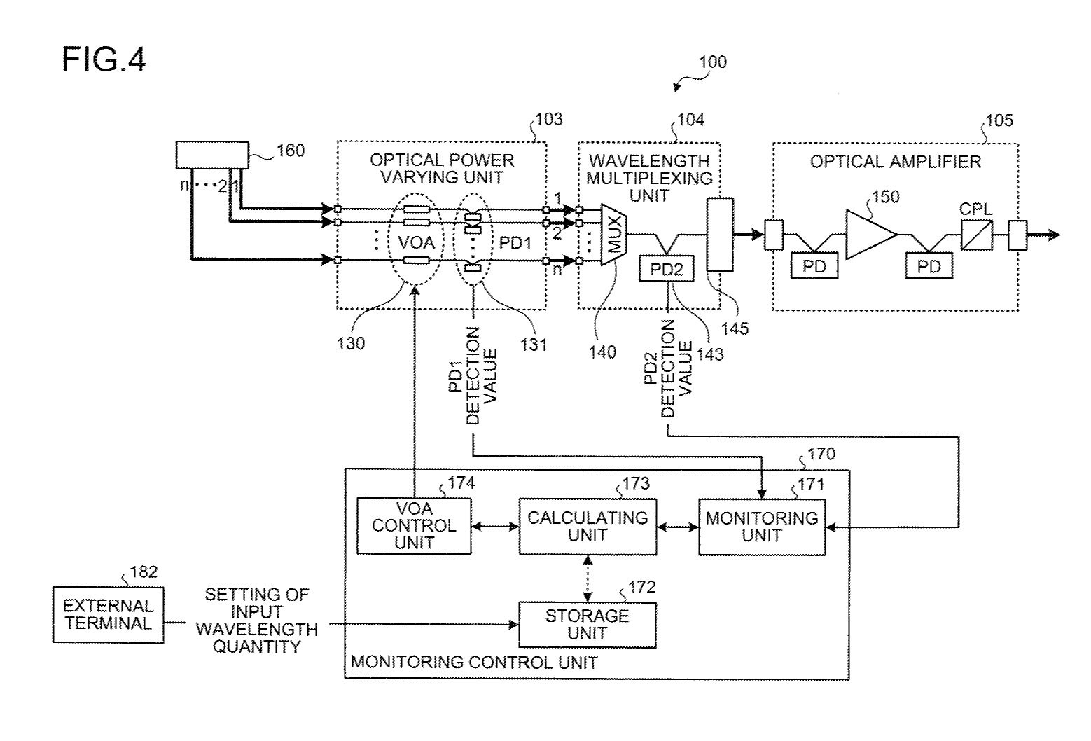

FIG. 4 is a schematic depicting a configuration of optical power adjustment during operation of the optical WDM transmission apparatus according to the first embodiment. As depicted in FIG. 4, during operation, the variable wavelength optical power source 180 is disconnected from the ports 160 and optical signals of wavelengths λ1 to n are input through the ports 160. Further, an optical amplifier 105 is connected to the downstream side of the wavelength multiplexing unit 104, and outputs the optical signal amplified by the post amplifier 150 to another optical WDM transmission apparatus downstream. The external terminal 182 outputs, to the monitoring control unit 107, the number of wavelengths of the optical signals input to the ports 160 (effective wavelengths).

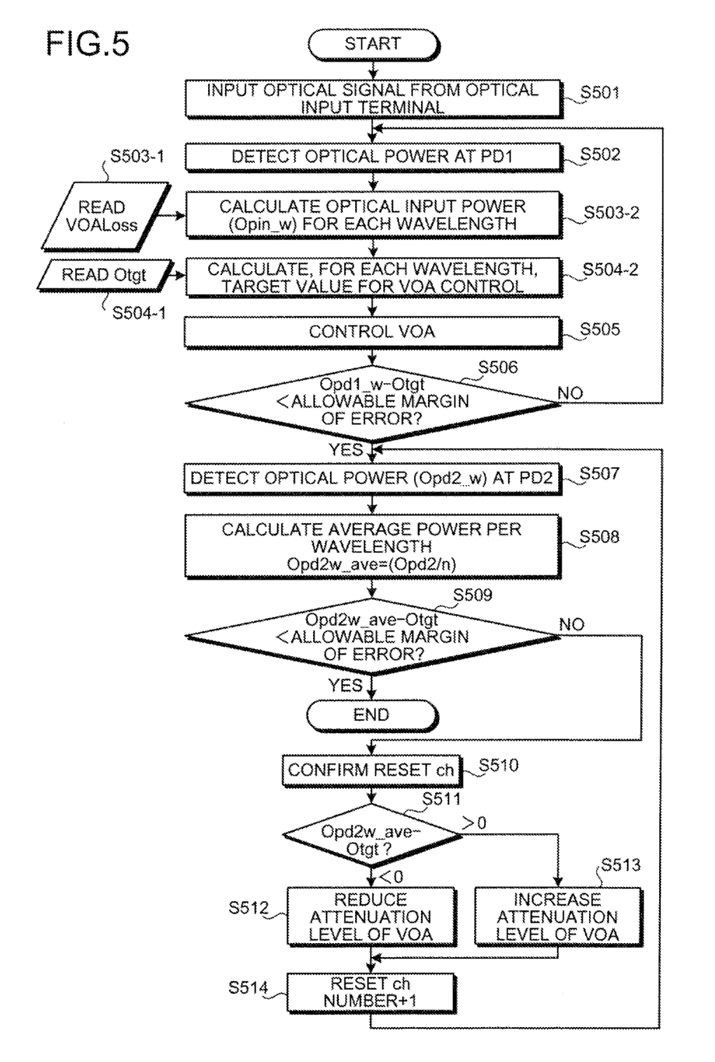

FIG. 5 is a flowchart of control processing during operation. Among the wavelengths λ1 to n, optical signals of the effective wavelengths are input through the ports 160, which are input terminals (step S501). Here, the input power is unknown (arbitrary) and the following processing is executed with respect to each wavelength in ascending order of wavelength.

The optical receivers (PD1) 131 detect the optical power for each wavelength input (step S502). The calculating unit 172 reads the loss VOALoss at the VOAs 130 from the storage unit 172 (step S503-1), and calculates the input optical power Opin_w for each wavelength (step S503-2). Here, processing is executed with respect to each wavelength in ascending order of wavelength.

input optical power for each wavelength Opin_{—}w=Opd1+VOALoss(min)+VOAλ

Where, VOAλ is the VOA attenuation level.

The calculating unit 173 reads the target input power Otgt from the storage unit 172 (step S504-1), and calculates a VOA control target value VOAtgt_w for each wavelength (step S504-2).

VOA control target value for a given wavelength VOAtgt_{—}w=Opin_{—}w−(Otgt+(Opd1_{—}w−Opd2_{—}w))

The VOA control unit 174 executes VOA control for adjusting the attenuation level of the VOAs 130 (step S505). Here, it is determined whether the difference of the optical power Opd1_w detected for a wavelength by an optical receiver (PD1) 131 and the target input power Otgt_w is below a predetermined allowable margin of error (step S506).

power Opd1_{—}w−Otgt>allowable margin of error

If the result of the comparison at step S506 exceeds the allowable margin of error (step S506: NO), processing returns to step S502 and VOA control is executed again. If the result is within the allowable margin of error (step S506: YES), the following processing is executed.

The optical output power Opd2 after multiplexing is detected by the optical receiver (PD2) 143 of the wavelength multiplexing unit 104 (step S507). An average power per wavelength Opd2w_ave is calculated (step S508). The optical receiver (PD2) 143 is disposed downstream from the MUX 140 and hence, the power for only one wavelength cannot be detected, i.e., the total power for all of the wavelengths in the multiplexed optical signal is detected by the optical receiver (PD2) 143. Thus, by dividing the total power detected Opd2 by the number of wavelengths n, an average power per wavelength is obtained.

average power per wavelength Opd2w_{—}ave=Opd2/n(mw)

Next, it is determined whether the difference of the average power per wavelength Opd2w_ave and the target input power Otgt of the post amplifier 150 is below a predetermined allowable margin of error (step S509).

average power per wavelength Opd2w_{—}ave−target input power Otgt>allowable margin of error

If the result of the comparison at step S509 indicates the difference to be within the allowable margin of error (step S506: YES), a series of the processing ends. On the other hand, if the result indicates the difference to exceed the allowable margin of error (step S506: NO), processing proceeds to step S510, and reset processing is executed.

At step S510, the wavelength (ch) to be subject to reset processing is confirmed (step S510). The larger of the average power per wavelength Opd2w_ave and the target input power Otgt of the post amplifier 150 is determined (step S511). Reset processing for the wavelength (ch) is executed in ascending order of wavelength.

the average power per wavelength Opd2w_{—}ave−the target input power Otgt

If the result of the comparison at step S511 indicates the average power per wavelength Opd2w_ave to be less than the target input power Otgt (step S511: <0), the VOA control unit 174 reduces the attenuation level of the VOA 130 (step S512); if the average power per wavelength Opd2w_ave is greater than the target input power Otgt (step S511: >0), the VOA control unit 174 increases the attenuation level of the VOA 130 (step S513). After steps S512 and S513, the number of the wavelength (ch) to be reset is updated by adding 1 (step S514), flow returns to step S507 and processing from step S507 is executed. Thus, the processing at step S509, i.e., control whereby the difference of the average power per wavelength Opd2w_ave and the target input power Otgt is within the predetermined allowable margin of error, is executed.

According to the control processing above, irrespective of optical signal bandwidth, or more specifically regardless of whether ASE is included, a wavelength multiplexed optical signal may be controlled to a desirable value for each wavelength included, wavelength deviation is eliminated, and the optical signal power for each wavelength may be made uniform and output. Further, with the configuration above, detection at the optical receiver (PD2) 143 after wavelength multiplexing and calculation of optical power per wavelength by the monitoring control unit 170 is used in VOA attenuation control; therefore, connection of an optical spectrum analyzer, optical channel monitor, optical power meter, etc. to the ports 160 is unnecessary.

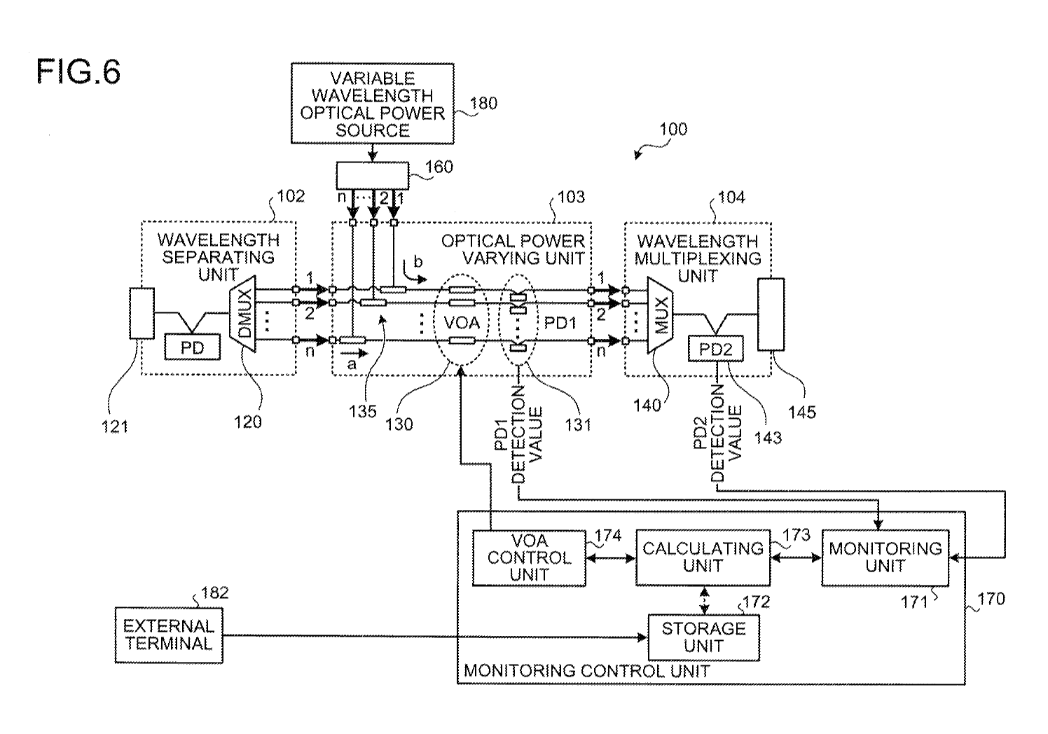

A second embodiment assumes a configuration that multiplexes optical signals demultiplexed by a DMUX and newly inserted (ADD) optical signals. FIG. 6 is a schematic depicting a configuration of optical power adjustment before operation of an optical WDM transmission apparatus according to the second embodiment. Elements identical to those depicted in FIG. 1 are given the same reference numerals used in FIG. 1.

As depicted in FIG. 6, on an input side of the optical WDM transmission apparatus 100, a wavelength separating unit 102 is provided, a multiplexed optical signal input to port 121 is demultiplexed by a DMUX 120 into respective wavelengths λ1 to n and the resulting optical signals of each wavelength are input to the optical power varying unit 103. The optical power varying unit 103 includes optical switches 135 upstream to the VOAs 130. The ports 160 for inserting optical signals (ADD) are connected to the optical switches 135, and light output from the variable wavelength optical power source 180 is input through the ports 160. The optical switches 135 may transmit (THROUGH) optical signals of wavelengths λ1 to n output from the wavelength separating unit 102 through paths (indicated as “a” in FIG. 6). Further, the optical switches 135 may add optical signals in paths (indicated as “b” in FIG. 6) from the ports 160 to the optical signals in the paths “a” by a switching.

The external terminal 182 outputs the number of input wavelengths, information concerning the optical signals (“a”) being transmitted in the apparatus, and information concerning the optical signals added (“b”) to the apparatus. The monitoring control unit 170, based on the above information, determines the input state of the optical signals. Processing for pre-operation preparation is identical to that of the first embodiment depicted in FIG. 2. Further, after completion of the pre-operation processing, the variable wavelength optical power source 180 is disconnected from the ports 160 initiating an operation state. In the operation state, through the ports 121 and 160, optical signals of arbitrary wavelengths and power are input, respectively.

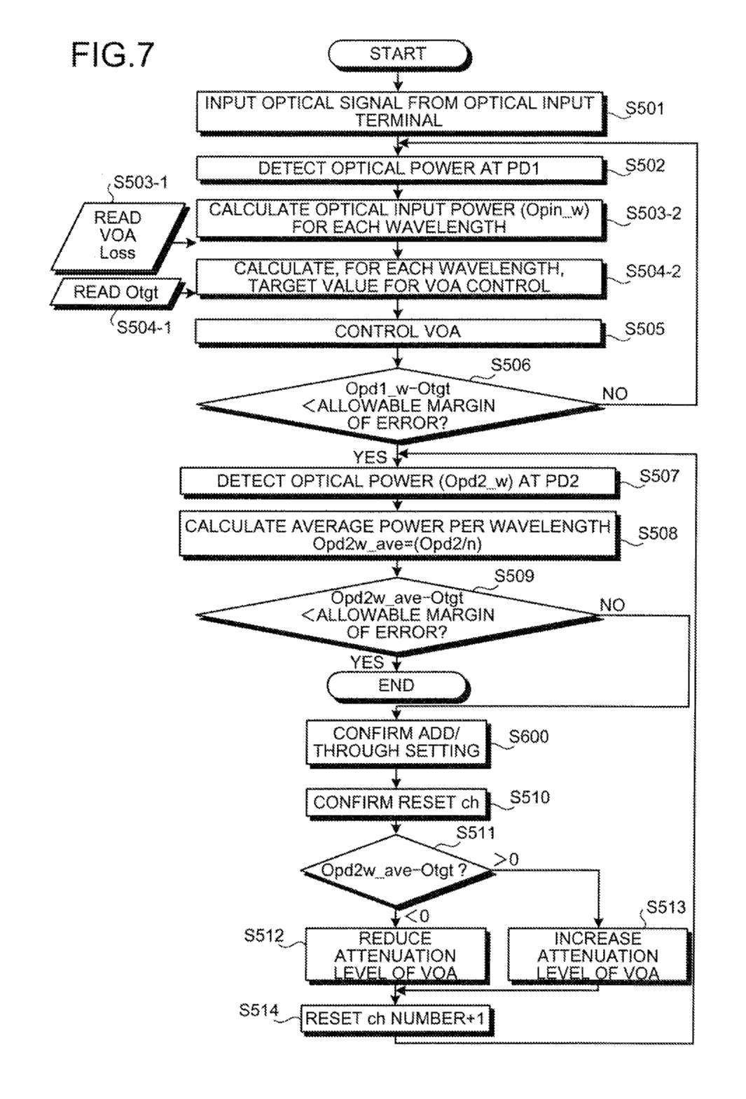

FIG. 7 is a flowchart of control processing during operation. As depicted in FIG. 7, the processing flow is for the most part, identical to that depicted in FIG. 5, and processing steps identical to those in FIG. 5 are given the same reference numerals used in FIG. 5. In the determination at step S509, if the difference of the average power per wavelength Opd2w_ave and the target input power Otgt of the post amplifier 150 exceeds a predetermined allowable margin of error (step S509: NO), the processing proceeds to step S510, and when reset processing is executed, it is determined whether the optical signal of focus is an inserted (ADD) optical signal or a transmitted (THROUGH) optical signal (step S600).

Thus, when the determination at step S509 indicates that the allowable margin of error is exceeded, because the ASE power has been removed by a filter property of the DMUX 120 from the optical signals in the paths “a” (THROUGH), the cause of the allowable margin of error being exceeded is determined to be optical signal inserted (path “b”) from the ports 160. The reset processing from step S510 may be attenuation control of the VOAs 130 performed with respect to the inserted optical signals and in ascending order of wavelength.

According to the processing above, irrespective of optical signal bandwidth, whether optical signals are transmitted through the apparatus or optical signals are inserted, a wavelength multiplexed optical signal may be controlled to a desirable value for each wavelength included, wavelength deviation is eliminated, and the optical signal power at each wavelength may be made uniform and output. The optical WDM transmission apparatus 100 is not limited to transmitting input optical signals, and may output (DROP) optical signals from the ports 160, receive new optical signals (ADD) through the ports 160, etc. Further, transmission paths in the network may vary from short distances to long distances. Although power associated with ASE components varies according to such factors, the above configuration enables the optical signal power for each wavelength to be made uniform and output.

As described, according to the embodiments, optical signal power may be appropriately adjusted for each wavelength and consequently, wavelength deviation of the wavelengths in a multiplexed optical signal is eliminated and signal quality is improved. Additionally, long distance transmission is enabled. The embodiments disclosed are applicable to optical WDM transmission apparatuses having at least VOAs and an MUX, and improve adjustment precision with respect to the optical power of the multiplexed optical signal output.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical WDM transmission apparatus comprising:
a plurality of optical attenuators that respectively attenuate the power of optical signals separated according to wavelength;
a plurality of first optical receivers that respectively detect the power of the attenuated optical signals;
a multiplexer that multiplexes the optical signals;
a second optical receiver that detects the power of the multiplexed optical signal; and
a monitoring control unit that includes:
a first control system that controls the optical attenuators so that the powers detected at the first optical receivers respectively become target values, and
a second control system that, based on the power detected by the second optical receiver and information concerning the number of wavelengths corresponding to the optical signals input, controls the optical attenuators so that the powers of the optical signals respectively become the target values.

2. The optical WDM transmission apparatus according to claim 1, wherein the monitoring control unit, when an optical signal of a given wavelength is input during a pre-operation state of the optical WDM transmission apparatus, obtains loss at the multiplexer for the given wavelength based on a difference of the power detected by a first optical receiver for the given wavelength and the power detected by the second optical receiver, and uses the obtained loss to achieve the target values.

3. The optical WDM transmission apparatus according to claim 1, wherein the monitoring control unit, during an operating state of the optical WDM transmission apparatus, obtains an optical signal power per wavelength by dividing the power detected by the second optical receiver by the number of wavelengths, and uses the obtained optical signal power per wavelength to achieve the target values.

4. The optical WDM transmission apparatus according to claim 1, wherein the monitoring control unit receives from an external source and uses to achieve the target values, the information concerning the number of wavelengths, and a target input power value that concerns a given wavelength and is for a post amplifier disposed downstream in the optical WDM transmission apparatus.

5. The optical WDM transmission apparatus according to claim 4, further comprising:
a plurality of optical switches that are for transmitting the optical signals and inserting optical signals, and that are disposed upstream from the optical attenuators, wherein
the monitoring control unit receives from the external source, information indicating whether an optical signal is a transmitted optical signal or an inserted optical signal; and when the powers of the optical signals deviate from the target values, re-executes control performed by the second control system with respect to an inserted optical signal.

6. The optical WDM transmission apparatus according to claim 1, wherein the second optical receiver uses an optical receiver disposed in a multiplexing unit that includes the multiplexer.

7. An optical WDM transmission method comprising:
attenuating respectively, by optical attenuators, the power of optical signals separated according to wavelength;
detecting respectively, by first optical receivers, the power of the attenuated optical signals;
multiplexing the optical signals by a multiplexer;
detecting, by a second optical receiver, the power of the multiplexed optical signal;
controlling the optical attenuators so that the powers detected at the detecting by the first optical receivers respectively become target values; and
controlling, based on the power detected at the detecting by the second optical receiver and information concerning the number of wavelengths corresponding to the optical signals input, the optical attenuators so that the powers of the optical signals respectively become the target values.

8. The optical WDM transmission method according to claim 7, further comprising:
performing, before the controlling of the optical attenuators so that the powers detected at the first optical receivers respectively become target values and during a pre-operation state, pre-operation processing that includes:
obtaining loss at the multiplexer for a given wavelength based on a difference of the power detected at the detecting by a first optical receiver for the given wavelength and the power detected at the detecting by the second optical receiver, and
using the obtained loss to achieve the target values.

9. The optical WDM transmission method according to claim 8, wherein the controlling based on the power detected at the detecting by the second optical receiver and information concerning the number of wavelengths, is performed during an operating state and includes:
obtaining an optical signal power per wavelength by dividing the power detected at the detecting by the second optical receiver by the number of wavelengths, and
using the obtained optical signal power per wavelength to achieve the target values.

10. The optical WDM transmission method according to claim 7, wherein the controlling based on the power detected at the detecting by the second optical receiver and information concerning the number of wavelengths, includes receiving from an external source and using to achieve the target values, the information concerning the number of wavelengths, and a target input power value that concerns a given wavelength and is for a post amplifier disposed downstream.

11. The optical WDM transmission method according to claim 10, wherein
a plurality of optical switches that are for transmitting the optical signals and inserting optical signals, are disposed upstream from the optical attenuators, and
the controlling based on the power detected at the detecting by the second optical receiver and information concerning the number of wavelengths, includes:
receiving from the external source, information indicating whether an optical signal is a transmitted optical signal or an inserted optical signal, and
re-executing control with respect to the inserted optical signal when the powers of the optical signals deviate from the target values.
